(19) United States
(12) Patent Application Publication
(10) Pub. No.: US 2026/0227482 A1
(43) Pub. Date: Aug. 6, 2026

(54) METHOD AND APPARATUS FOR DETERMINING AT LEAST ONE CHARACTERISTIC OF A SIGNAL PROPAGATION PATH

(71) Applicant: FOCAL POINT POSITIONING LIMITED, Cambridge (GB)

(72) Inventors: Ramsey Michael FARAGHER, Cambridge (GB); Robert Mark CROCKETT, Cambridge (GB); Peter James DUFFETT-SMITH, Cambridge (GB)

(21) Appl. No.: 19/150,566

(22) PCT Filed: Jan. 30, 2024
(86) PCT No.: PCT/GB2024/050257

§ 371 Date: Jul. 24, 2025

Related U.S. Application Data
(60) Provisional application No. 63/442,244, filed on Jan. 31, 2023.

(51) Int. Cl. G01S 5/02; G01S 3/02; G01S 3/52; G01S 19/42

(52) U.S. Cl. CPC G01S 5/0273; G01S 3/023; G01S 3/52; G01S 19/428

(57) ABSTRACT

A method, apparatus, and system for determining at least one characteristic of a signal propagation path between a transmitter and a receiver in a communication environment include determining a motion of an antenna of the receiver, compensating the received signals, a plurality of local signals or correlation results using a plurality of phasors sequences, where each phasor sequence represents a hypothesis, to generate a plurality of compensated correlation results, identifying a direction of arrival for the received signals using a determined preferred hypothesis that optimizes each correlation result, determining, based on the identified direction of arrival a propagation path for each of the plurality of received signals, and determining at least one characteristic of a propagation path for at least one of the plurality of received signals based on the identified direction of arrival of the propagation path and information regarding the communication environment of the receiver.

### CROSS-REFERENCE TO RELATED APPLICATIONS

This application claims benefit of and priority to U.S. Provisional Patent Application Ser. No. 63/442,244 filed Jan. 31, 2023, which is herein incorporated by reference in its entirety.

### FIELD

Embodiments of the present principles generally relate to radio signal processing and, in particular, to a method, apparatus and system for determining at least one characteristic of a signal propagation path.

### BACKGROUND

Radio transmissions are used in various communications and positioning systems. For example, WiFi, using the IEEE 802.11a, b, g, n, ac standards, has become ubiquitous for short range data communications. WiFi access points (also referred to as WiFi hotspots) comprise radio transceivers that broadcast 2.4 or 5 GHz signals using a narrowband signal (e.g., 22 MHz). Cellular telephone signals for GPRS, GSM, etc. are used for communications amongst cellular telephones and their associated base stations. Global Navigation Satellite System (GNSS) receivers are included in many electronic devices, including smartphones, to determine the geolocation of the device. GNSS receivers operate using signals from satellites in one or more of the commercially available GNSS satellite systems, including GPS, GLONASS, BeiDou, etc. The receivers for one or more of these systems may be contained in user equipment (UE) such as laptop computers, cellular telephones, tablets, Internet of Things (IoT) devices, positioning devices, and the like.

All of these communications and positioning systems utilize transmitted signals that experience multipath interference resulting from signal reflections from buildings, mountains, automobiles, walls, etc. A receiver typically receives a direct signal (i.e., line-of sight (LOS) signal) that propagates from the transmitter to the receiver and may receive one or more indirect signals (i.e., non-line-of-sight (NLOS) signal(s)) that are reflected versions of the direct signal that may be reflected one or more times before reaching the receiver. The indirect signals are delayed during their propagation path when compared to the arrival time of the direct signal. Consequently, the indirect signals interfere with the reception of the direct signal. In some instances, a receiver may only receive indirect signals because an object, such as a building, may impede the direct signal propagation path.

Generally, a receiver receives both indirect and direct signals and processes all the received signals to extract the data from the signals. If the multipath interference is significant, the receiver may miss some data and/or lose position for a period of time. With a moving receiver, the interference is generally intermittent and constantly changing.

It would be helpful to receiver operation if the characteristics (e.g., direction of arrival, reflection location, polarization, number of reflections, etc.) of the indirect propagation path or paths were known such that the receiver could process the indirect signals to be useful in signal reception and/or suppress the indirect signals that cause significant interference. Currently, there is not a technique that could determine characteristics of the propagation paths of indirect signals such that the path characteristics could be used to enhance signal reception.

Therefore, there is a need for a method, apparatus and system for determining at least one characteristic of a signal propagation path.

### SUMMARY OF INVENTION

Embodiments of the present principles generally relate to a method, apparatus and system for determining characteristics of a signal propagation path as shown in and/or described in connection with at least one of the figures.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a communication environment in which a receiver that receives signals transmitted by one or more transmitters can be implemented in accordance with at least one embodiment of the present principles;

FIG. 2 depicts a communication environment in which a receiver that receives signals propagating along propagation paths having various characteristics can be implemented in accordance with at least one embodiment of the present principles;

FIG. 3 depicts a high-level block diagram of the receiver of FIGS. 1 and 2 in accordance with at least one embodiment of the present principles; and

FIG. 4 depicts a flow diagram of a method for determining characteristics of a signal propagation path in accordance with at least one embodiment of the present principles.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for determining at least one propagation path characteristic for one or more radio signals. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims.

Digital communications systems, such as cellular, Bluetooth or WiFi, and positioning systems, such as GNSS, utilize encoded digital radio signals to improve signal throughput and security. These systems use some form of deterministic digital code to facilitate signal acquisition (e.g., acquisition codes such as Gold codes, Barker codes, etc.). Such a digital code is deterministic by the receiver and repeatedly broadcast by the transmitter to enable the receivers to acquire and receive the transmitted signals. Using such deterministic codes combined with an accurate motion model of a receiver, embodiments of the present principles are useful for isolating signal propagation paths along specific directions of arrival (DoA) and determining at least one propagation path characteristic, such as reflection angle of incidence, signal polarization, reflective surface characterization, number of reflections, etc. The signal can propagate directly (e.g., line-of-sight (LOS)) or indirectly via one or more reflections (e.g., non-line-of-sight (NLOS)). In some embodiments, a technique for determining DoA using receiver motion information in accordance with the present principles can include SUPERCORRELATION™ which is described in commonly assigned U.S. Pat. No. 9,780,829, issued 3 Oct. 2017; U.S. Pat. No. 10,321,430, issued 11 Jun. 2019; U.S. Pat. No. 10,816,672, issued 27 Oct. 2020; US patent publication 2020/0264317, published 20 Aug. 2020; and US patent publication 2020/0319347, published 8 Oct. 2020. The DoA information can be combined with/compared to/used with information regarding an operating environment, such as a three-dimensional (3D) model of the receiver's surrounding environment, to enable a signal processor to determine characteristics of an identified signal path including at least one of signal polarization, reflected signal angle of incidence, number of times a reflected signal has been reflected and the like. In some embodiments, the 3D model can comprise geometric information regarding reflective surfaces proximate the receiver including buildings, signposts, telephone poles, and other objects that reflect radio signals. The geometric information can include one or more of, but is not limited to, reflector location, size, shape, and material. Such information can be used by a receiver of the present principles in deciding which received signals to use for further processing (described in greater detail below).

In some embodiments, a receiver can be moved through a space containing a transmitter (e.g., including but not limited to, WiFi, Bluetooth, cellular, GNSS, etc.) and can identify signal propagation paths (LOS and NLOS) and characteristics of those paths. With knowledge of the location of the transmitter (e.g., a WiFi access point or hotspot, cellular tower, GNSS satellite, etc.) and knowledge of the receiver position and receiver motion, embodiments of the present principles can determine the propagation paths for LOS and NLOS signals.

In some embodiments, receiver and transmitter positions can be a priori provided or can be determined by the receiver. The positions can be absolute (world geographic coordinates) or can be relative (arbitrary coordinate system). By combining the propagation paths with a 3D model of the receiver's surroundings, the receiver can determine the characteristics of the signal propagation paths such as, but not limited to, signal polarization, reflected signal angle of incidence, a number of times a reflected signal has been reflected, and so on. The functions of embodiments of the present principles can be embedded into cellular telephones, Internet of Things (IoT) devices, mobile computers, tablets, communication channel analyzers, and the like. Embodiments of the present principles can be used on any moving receiver that receives signals having a code that can be correlated with a locally generated code. Such a receiver need only be able to utilize a deterministic acquisition code contained in the received signal. Although the receiver can receive the signal and utilize a full data message of the signal (i.e., WiFi, Bluetooth, GNSS or cellular enabled), a receiver of the present principles does not have to be fully enabled.

Some embodiments of the present principles can perform signal processing locally on the moving platform. In other embodiments, the receiver motion information and receiver position information can be gathered at the moving platform and communicated (wired or wirelessly) to a server for remote processing in real-time or at a later time. In some embodiments, the signal geometry is known (e.g., known source location, known 3D model of the environment and estimate of the receiver location) and can be used to predict the direction of arrival of the “best” signals to receive. By doing so, the search space used in the SUPERCORRELATION™ process can be reduced. For example, in a GNSS, the satellite locations are known, the receiver location can be estimated, and a 3D building model can be used in a ray tracing algorithm to determine which signal directions of arrival have direct propagation paths and signal reflection paths with sufficiently small angles of incidence (e.g., for GNSS signals, a sufficiently small angle of incidence is one that is less than about 75 degrees). More generally, a sufficiently small angle of incidence depends on the DoA angle resolution of the SUPERCORRELATION™ process, which depends on signal frequency and the motion of a receiver. For example, a 1-degree angular resolution can be achieved for a 1 second SUPERCORRELATION process at 1 GHz with the receiver moving at 5 m/s. The SUPERCORRELATION process can then be used to receive signals in the expected directions. Once those signals are confirmed as having the best characteristics, the selected received signals can be used in the position solution calculation.

For example, in some embodiments a position of a receiver can be determined based on at least a known position of the transmitter, an identified direction of arrival of at least one of the plurality of signals received from the transmitter, and a determined at least one characteristic of the propagation path for the at least one of the plurality of signals received from the transmitter.

Alternatively or in addition, in some embodiments a position of a transmitter can be determined based on at least an estimated position of the receiver, an identified direction of arrival of at least one of the plurality of signals received from the transmitter, and a determined at least one characteristic of the propagation path for the at least one of the plurality of signals received from the transmitter.

In other embodiments, from a determination of a reflected signal's path length, a delay with respect to a LOS signal can be computed. The delay can be used to compensate for additional path length (delay) of an NLOS signal, such that the NLOS signal can be used in a positioning solution as if it were a LOS signal.

In addition, in some embodiments, signals reflected from the ground provide additional signals to use in a positioning solution to improve the accuracy of the altitude component in the three-dimensional (3D) position of a receiver. For example, on an aircraft based GNSS receiver, the DOA of ground reflected signals and a 3D model of the ground enable using the ground reflected GNSS signals in a positioning solution for the aircraft. Having the additional signals arriving from directions below the aircraft is beneficial to improving the altitude component of the aircraft's 3D position.

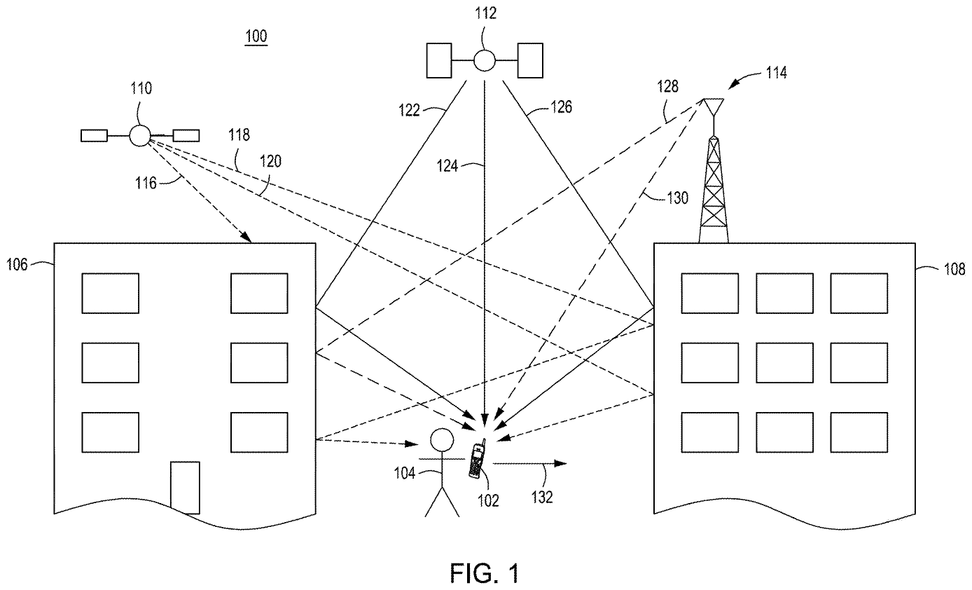

FIG. 1 depicts a communication environment 100 in which a receiver that receives signals transmitted by one or more transmitters can be implemented in accordance with at least one embodiment of the present principles. In the embodiment of FIG. 1, at least one receiver 102 receives signals broadcast from, illustratively, three transmitters 110, 112, 114. That is, as the at least one receiver 102 is being carried by a person 104 through the communication environment 100, the receiver 102 receives signals from the signal transmitter(s) 110, 112, 114 and determines the characteristics of the signal propagation paths 116, 118,120, 122, 124, 126, 128 and 130 in accordance with the present principles. In communication environment 100 of FIG. 1, the at least one receiver 102 is operating in a high multipath environment, such as between buildings 106 and 108 (i.e., an urban canyon).

In the embodiment of FIG. 1, the receiver 102 moves through the area with knowledge of an estimate of its position either from: (1) a global navigation satellite (GNSS) receiver and/or an inertial navigation system (INS) or (2) position knowledge from a map or visual odometry/positioning (e.g., knowledge of landmarks with known locations within the area). In the embodiment of FIG. 1, signals from the transmitters 110, 112, 114 propagate along direct and indirect paths. For example, signals transmitted from transmitter 112 (e.g., a GNSS satellite) travel to the receiver 102, for example, along a direct path 124 and two indirect paths 122 and 126. The indirect paths are formed by the signals reflecting from the buildings 106 and 108. Similarly, signals from the transmitter 110 (e.g., a GNSS satellite) propagate to the receiver along paths 118 and 120, where both paths are indirect paths. In the embodiment of FIG. 1, the direct path 116 is blocked by building 106. The transmitter 114 (e.g., a cellular signal transmitter) propagates signals along paths 128 (indirect path) and 130 (direct path).

In accordance with the present principles, the characteristics of the propagation paths can be determined using the DoA of the signals. As the receiver 102 moves, the DoA of the propagation paths is determined. In some embodiments, the DoA information can be combined with a 3D model of the surrounding area (e.g., knowledge of signal reflector geometric information such as building locations and building sizes) to determine the characteristics of the propagation paths. In some embodiments, the characteristics can include, but are not limited to, signal polarization, reflected signal angle of incidence, number of times a reflected signal has been reflected, and the like. The propagation path information can be used by the receiver to select the “best” signals to process and extract data. For example, a GNSS satellite signal that has a small angle of incidence for a reflection is better suited for processing than a signal with a large angle of incidence (i.e., a glancing signal). Consequently, the receiver 102 can select the better signal to use in computing a position solution. Alternatively or in addition, depending upon the number of reflections in the propagation path, the receiver 102 can determine the polarization shift of the received signals (i.e., each reflection causes a reversal of polarization). That is, knowing the signal polarization can be helpful in systems that use antennas that are sensitive to signal polarization.

As will be described in greater detail below, in some embodiments, the at least one receiver 102 can implement a SUPERCORRELATION™ technique as described in commonly assigned U.S. Pat. No. 9,780,829, issued 3 Oct. 2017; U.S. Pat. No. 10,321,430, issued 11 Jun. 2019; U.S. Pat. No. 10,816,672, issued 27 Oct. 2020; US patent publication 2020/0264317, published 20 Aug. 2020; and US patent publication 2020/0319347, published 8 Oct. 2020, which are hereby incorporated herein by reference in their entireties. The SUPERCORRELATION™ technique enables a receiver of the present principles to determine a direction of arrival (DoA) of signals (e.g., both LOS and NLOS signals) received at the receiver from at least one transmitter. In the embodiment of FIG. 1, as the receiver 102 moves (represented by arrow 132) in the communication environment 100, the receiver 102 computes motion information representing motion of the receiver 102. The motion information determined for the receiver 102/antenna is used to perform motion compensated correlation of the received signals. From the motion compensated correlation process, the receiver 102 estimates the DoA of received signals. The receiver 102 uses the DoA data and a 3D model of the surrounding environment to determine the characteristics of the propagation paths.

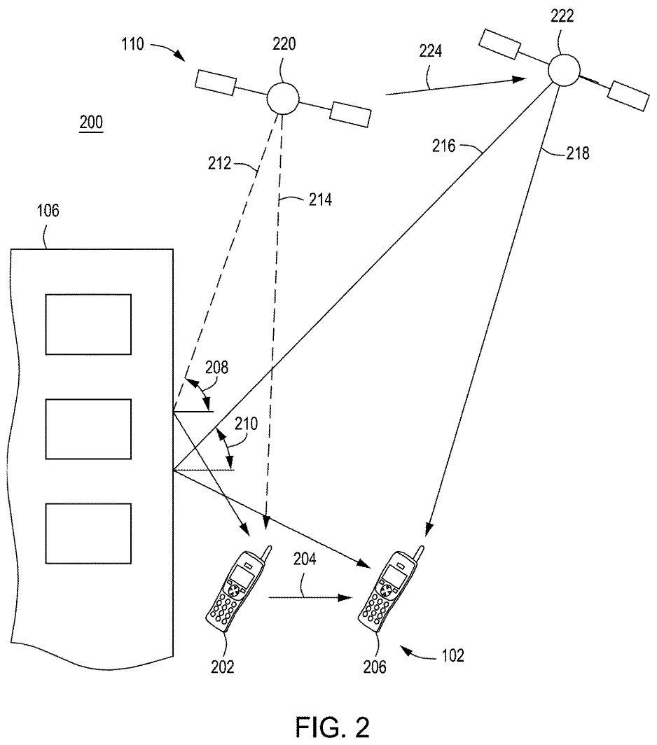

FIG. 2 depicts a communication environment 200 in which a receiver that receives signals propagating along propagation paths having various characteristics can be implemented in accordance with at least one embodiment of the present principles. In the embodiment of FIG. 2, the receiver 102 is moving along path 204 from position 202 to position 206 and the receiver 102 determines the characteristics of the signal propagation paths in accordance with at least one embodiment of the present principles. The communication environment 200 of FIG. 2 illustratively comprises a building 106, a receiver 102 and a transmitter 110 (e.g., a GNSS satellite). In the embodiment of FIG. 2, the transmitter 110 moves from position 220 along path 224 to position 222. At position 220, the transmitter 110 transmits signals along path 212 (indirect) and path 214 (direct). The signal on the indirect path 212 reflects from building 106 at a large angle of incidence 208 (i.e., a glancing reflection). In the embodiment of FIG. 2, as the satellite moves from position 220 to position 222 and the receiver 102 moves from position 202 to position 206, the propagation path changes to have a smaller angle of incidence 210 for the indirect path 216.

In the embodiment of FIG. 2, the receiver 102 processes the received signals as will be described in further detail below. Once the characteristics of the propagation paths are determined, the receiver selects the “best” signals for further processing and can use one or more of the determined characteristics to improve signal processing. That is, in some embodiments, the receiver 102 can determine the angle of incidence of the received indirect signals. Signals with large (glancing reflection) angle of incidence (e.g., path 212) can be ignored and not processed by the receiver (e.g., not used in a position solution). When the angle of incidence is small, as shown by path 216, the signal can be used in determining a position solution for, for example, a transmitter/signal source. In addition, the receiver 102 can determine that the path 216 has arrived along a direction that can be predicted using information regarding the communication environment, such as building models and the like, and can compensate for the extra path length due to the associated signal reflection or reflections when determining, for example, positions of transmitters/sources of received signals.

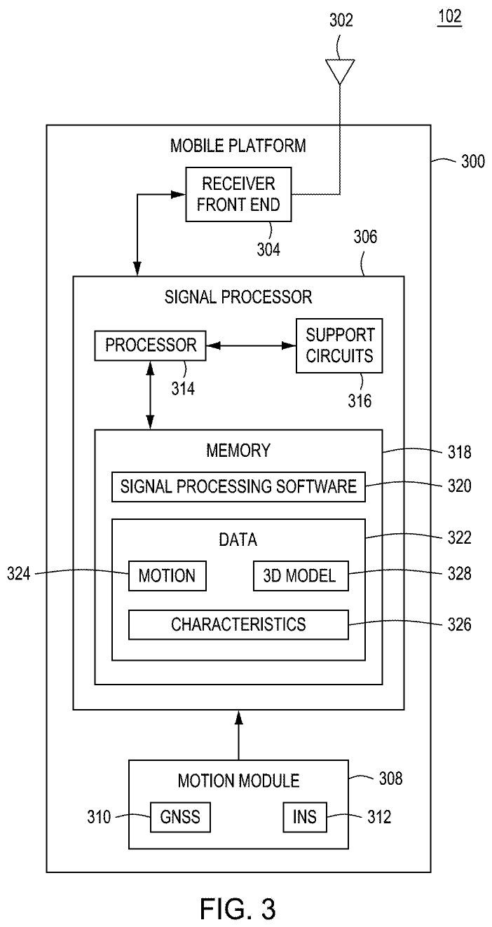

FIG. 3 depicts a high-level block diagram of the receiver 102 of FIGS. 1 and 2 in accordance with at least one embodiment of the present principles. In the embodiment of FIG. 3, the receiver 102 comprises a mobile platform 300, an antenna 302, a receiver front end 304, a signal processor 306, and motion module 308. The receiver 102 of FIG. 3 can incorporate a portion of a laptop computer, mobile phone, tablet computer, Internet of Things (IoT) device, purpose-built positioning device, channel characterizing device, and the like. In some embodiments such as the embodiment of FIG. 3, the receiver 102 and the antenna 302 are an indivisible unit, in which the antenna 302 moves with the positioning module 308. In such embodiments, the functionality of the SUPERCORRELATION™ technique operates based upon determining the motion of the signal receiving antenna 302. As such, any mention of motion herein refers to the motion of the antenna 302. In alternate embodiments however, the antenna 302 can comprise a separate device from the mobile platform 300. In such embodiments, the motion estimate used in the motion compensated correlation process is the motion of the antenna 302.

In the embodiment of FIG. 3, the mobile platform 300 comprises a receiver front end 304, a signal processor 306 and a motion module 308. The receiver front end 304 down-converts, filters, and samples (digitizes) the signals received by the antenna 302 in a manner that is well-known to those skilled in the art. The output of the receiver front end 304 is a digital signal containing data. The data of interest is a deterministic training or acquisition code used by the transmitter to synchronize the transmission to the receiver (e.g., a WiFi transceiver).

In the embodiment of FIG. 3, the signal processor 306 comprises at least one processor 314, support circuits 316 and a memory 318. The at least one processor 314 can comprise any form of processor or combination of processors including, but not limited to, central processing units, microprocessors, microcontrollers, field programmable gate arrays, graphics processing units, digital signal processors, and the like. The support circuits 316 can comprise well-known circuits and devices facilitating functionality of the processor(s). The support circuits 316 can comprise one or more of, or a combination of, power supplies, clock circuits, analog to digital converters, communications circuits, cache, displays, and/or the like.

In the embodiment of FIG. 3, the memory 318 can include one or more forms of non-transitory computer readable media including one or more of, or any combination of, read-only memory or random-access memory. The memory 318 can store software and data including, for example, signal processing software 320 and data 322. The data 322 can include receiver motion information 324, propagation path characteristics 326, a 3D model 328, and various other data used to perform, for example, the SUPERCORRELATION™ processing of the present principles. The signal processing software 320, when executed by the one or more processors 314, can perform motion compensated correlation on the received signals in accordance with the present principles to estimate the DoA vectors for the received signals. The motion compensated correlation process of the present principles is described in greater detail below.

In the embodiment of FIG. 3, the motion module 308 generates a motion estimate for the antenna 302. The motion module 308 can include an inertial navigation system (INS) 312 as well as a global navigation satellite system (GNSS) receiver 310 such as GPS, GLONASS, GALILEO, BeiDou, and the like. In some embodiments, the INS 312 can include one or more of, but not limited to, a gyroscope, a magnetometer, an accelerometer, and the like. To facilitate motion compensated correlation, the motion module 308 produces motion information (sometimes referred to as a motion model) including at least a velocity of the antenna 302 in the direction of interest, i.e., an estimated direction of a source of a received signal or a reflection point of a received reflected signal. In some embodiments, the motion information can also include estimates of platform orientation or heading including, but not limited to, pitch, roll and yaw of the platform 300/antenna 302. In some embodiments and as described in more detail below, the receiver 102 can test every direction and iteratively narrow the search to one or more directions of interest. That is, in some embodiments, the receiver 102 uses a priori knowledge of the receiver position, a 3D map of the immediate environment, transmitter location, and the like to narrow the range of parameters to be searched.

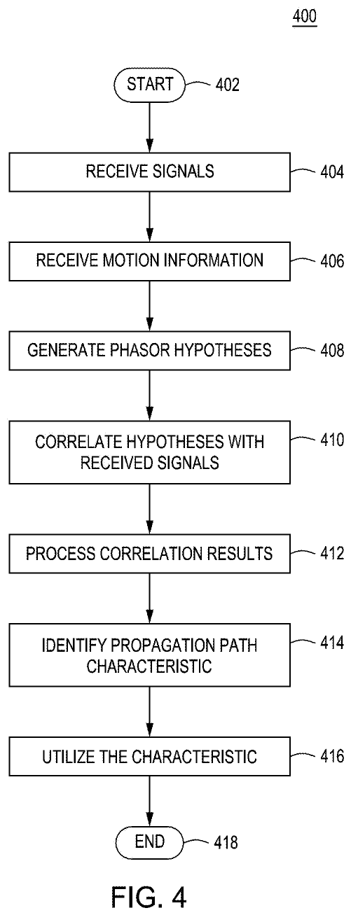

FIG. 4 depicts a flow diagram of a method 400 for determining characteristics of a signal propagation path in accordance with at least one embodiment of the present principles, which in some embodiments can be performed by the signal processing software 216 in accordance with at least one embodiment of the present principles. The method 400 of FIG. 4 can be implemented in software, hardware or a combination of both (e.g., using the signal processor 206 of FIG. 2).

The method 400 of FIG. 4 can begin at 402 and proceeds to 404 during which signals are received at a receiver/antenna from a remote source (e.g., transmitter 110, 112, 114) in a manner as described with respect to FIGS. 1, 2 and 3. Each received signal comprises a synchronization or acquisition code (i.e., a deterministic code, extracted from the radio frequency (RF) signal received at the antenna). The process of down-converting the RF signal and extracting the digital code once the signal is received is well known in the art and is not described herein. At 406, motion information is received from, for example, the motion module 308 of FIG. 3. The motion information can include an estimate of the motion of the receiver 102 of FIG. 1 and/or the antenna 302 of FIG. 3, including one or more of velocity, heading, orientation, and the like.

At 408, a plurality of phasor sequence hypotheses are generated related to a direction of interest of the received signal, for example, a direction of the transmitter and/or a direction of one or more reflections. In some embodiments, the hypotheses comprise a plurality of local signals representing code phase estimates. Each phasor sequence hypothesis comprises a series of phase offsets that vary with parameters of the receiver such as motion, frequency, DoA of the received signals, and the like. The signal processing correlates a local code encoded in a local signal with a code encoded in the received RF signal. In one embodiment, the phasor sequence hypotheses are used to adjust, for example at a sub-wavelength accuracy, the carrier phase of the local code over one or more periods (lengths) of the received code. Such adjustment or compensation can be performed by adjusting a local oscillator signal, the received signal(s), or the correlation result, to produce a phase compensated correlation result. In some embodiments, the signals and/or correlation results are complex signals comprising in-phase (I) and quadrature phase (Q) components. Each phase offset in the phasor sequence is applied to a corresponding complex sample in the signals or correlation results. If the phase adjustment is or includes an adjustment for receiver motion, then the result is a motion compensated correlation result.

At 410, for each received signal, the received signals are correlated with a set (plurality) of direction hypotheses containing estimates of a phase offset necessary to accurately correlate the received signals arriving from particular directions. That is, there is a set of hypotheses representing a search space for each received signal and each parameter of interest (e.g., motion, frequency, frequency rate, DoA, etc.). In some embodiments, since the signal is received from a single transmitter, the set of hypotheses for newly received signals from the transmitter includes a group of phasor sequence hypotheses using the expected Doppler and Doppler rate and/or a last Doppler and last Doppler rate used in receiving the prior signal from that transmitter. The values can be centered around the last values used or the last values used additionally offset by a prediction of further offset based on the expected receiver motion. More specifically, at 410, each received signal is correlated with that signal's set of hypotheses. The hypotheses are used as parameters to form the phase-compensated phasors to phase compensate the correlation process. As such, the phase compensation can be applied to the received signals, the local frequency source (e.g., an oscillator), or the correlation result values. The hypotheses collectively form a search space within which each of the hypotheses can be analyzed/tested to determine a preferred hypothesis.

In some embodiments, in addition to searching over the DoA space, the hypotheses related to other parameters, such as oscillator frequency, can be applied to correct frequency and/or phase drift, or heading to ensure the correct motion compensation is being applied. The result of the correlation process can include a plurality of phase-compensated correlation results-one phase-compensated correlation result value for each hypothesis for each received signal. Any drift and perturbations in the transmitter oscillator are contained in the direct signal and all of its reflected signals. The receiver oscillator can therefore easily be referenced against the transmitter oscillator using the line of sight signal or any of its reflected signals once the Doppler effect from the receiver motion has been accounted for and the 3D building model has been used to remove or compensate for any extra path length (i.e., delay) associated with a reflected signal. The reflected signals can then be used in further processing in the same manner as a direct signal (i.e., in joint estimation processes and other techniques to monitor or remove any of the clock errors in the system).

Referring back to FIG. 4, at 412, the correlation results are processed/analyzed to find the “best” or optimal result for each received signal (i.e., isolate each signal using an optimal DoA hypothesis). In some embodiments, the a joint correlation output is produced as a function (e.g., summation) of the plurality of correlation results resulting from all the hypotheses and all received signals. The joint correlation output can be a single value or a plurality of values that represent the parameter hypotheses (e.g., preferred hypotheses) that provide an optimal or best correlation output.

In some embodiments, a cost function is applied to each set of correlation values for each received signal to find the optimal correlation output corresponding to a preferred hypothesis or hypotheses. The joint correlation output reveals the frequency and frequency rate offset between the receiver oscillator and the transmitter oscillator, enabling the receiver to be synchronized to the transmitter.

In other embodiments, rather than using the largest magnitude correlation value, other test criteria can be used. For example, in some embodiments, the progression of correlations as hypotheses are tested and a cost function is applied that indicates the best hypotheses when the cost function reaches a minimum (e.g., a small hamming distance amongst peaks in the correlation plots). As such, the joint correlation output can be a joint correlation value or a group of values. In other embodiments, additional hypotheses can be tested in addition to the DoA hypotheses to, for example, ensure the motion compensation (e.g., speed and heading) is correct.

At 414, the propagation path characteristics associated with each DoA vector of each received signal are identified. In one embodiment, information regarding an environment in which a receiver of the present principles is operating, such as a three-dimensional model of the surrounding environment, can be implemented. The DoA vectors are mapped to the model to determine path characteristics of received signals, such as the angle of reflection, number of reflections, whether a direct signal is partially or fully blocked by a building, etc. In some embodiments, the mapping of the vectors to the 3D model can be performed using ray tracing techniques.

At 416, for a propagation path, a receiver of the present principles can use the determined characteristics to select signals having optimal or best characteristics to receive and process the signals. For example, in some embodiments only GNSS signals with direct paths and reflected signals with a large reflection angle of incidence are selected to use in the position solution computation of at least a transmitter/source of the signal and/or the receiver. Alternatively or in addition, in some embodiments, cellular signals having a direct path and signals with a single reflection can be selected for extracting communications data. In some embodiments, knowledge of the source location, receiver location and 3D model can be used to determine predicted signal DoAs. The predicted DoAs can be compared to generated, known accurate DoA vectors to identify inaccuracies in, for example, the environment information, such as the 3D model. If the predicted and true vectors are not substantially similar, a provider/developer of the information/model can be notified of the inaccuracy. In addition, the delays used for correcting the signals from the inaccurate predicted DoAs can be corrected before use in a position solution.

In some embodiments, propagation path characteristics determined in accordance with the present principles can be used to predict a minimum number of signals to use in the SUPERCORRELATION™ process to achieve a maximum accuracy of a position solution.

In some embodiments, the propagation characteristics are used to assist in signal selection to avoid using signals that are reflected from odd-shaped buildings or statues or from buildings constructed from poor radio signal reflective materials. The environment information, such as the 3D model, can be used to identify signals arriving from structures that are poor radio signal reflectors. As such, the receiver can focus computation resources on signals that are reflected from very reflective surfaces.

The method 400 ends at 418.

Embodiments of the present principles can be used to generate maps identifying radio signal reflective surface (e.g., room maps, urban canyon city maps, etc.). Alternatively or in addition, the techniques described herein can be used to confirm the accuracy of a priori provided surface maps. Consequently, provided inaccurate maps can be identified for correction or can be eliminated from use in current position location calculations.

In some embodiments of the present principles there is provided a method for determining at least one characteristic of a propagation path between a transmitter and a receiver in a communication environment including receiving a plurality of signals transmitted from the transmitter, where each of the plurality of signals has a different propagation path, determining a motion of an antenna of the receiver, generating a plurality of phasors sequences, where each phasor sequence represents a hypothesis based on antenna motion and a direction of arrival estimate for each of the plurality of received signals, compensating the plurality of received signals, a plurality of local signals or correlation results from correlating the plurality of received signals with the local signals using the plurality of phasor sequences based on the plurality of hypotheses regarding the receiver motion and the direction of arrival estimate to generate a plurality of compensated correlation results, determining a preferred hypothesis in the plurality of hypotheses for each received signal that optimizes each correlation result in the plurality of compensated correlation result, identifying a direction of arrival for each of the plurality of received signals using the determined preferred hypothesis, determining, based on the identified direction of arrival, a propagation path for each of the plurality of received signals, and determining at least one characteristic of a propagation path for at least one of the plurality of received signals based on the identified direction of arrival of the propagation path and information regarding the communication environment of the receiver.

In some embodiments there is provided an apparatus for determining at least one characteristic of a propagation path between a transmitter and a receiver in a communication environment including at least one processor and at least one memory for storing programs and instructions. In such embodiments when the programs and instructions are executed by the at least one processor, the apparatus performs operations including receiving a plurality of signals transmitted from the transmitter, where each of the plurality of signals has a different propagation path, determining a motion of an antenna of the receiver, generating a plurality of phasors sequences, where each phasor sequence represents a hypothesis based on antenna motion and a direction of arrival estimate for each of the plurality of received signal, compensating the plurality of received signals, a plurality of local signals or correlation results from correlating the plurality of received signals with the local signals using the plurality of phasor sequences based on the plurality of hypotheses regarding the receiver motion and the direction of arrival estimate to generate a plurality of compensated correlation results, determining a preferred hypothesis in the plurality of hypotheses for each received signal that optimizes each correlation result in the plurality of compensated correlation results, identifying a direction of arrival for each of the plurality of received signals using the determined preferred hypothesis, determining, based on the identified direction of arrival, a propagation path for each of the plurality of received signals, and determining at least one characteristic of a propagation path for at least one of the plurality of received signals based on the identified direction of arrival of the propagation path and information regarding the communication environment of the receiver.

In some embodiments there is provided a system for determining at least one characteristic of a propagation path between a transmitter and a receiver in a communication environment including at least one transmitter, a receiver including an antenna, a motion module, and an apparatus including at least one processor and at least one memory for storing programs and instructions. In some embodiments, when the programs and instructions are executed by the at least one processor, the apparatus performs operations including receiving, at the antenna of the receiver, a plurality of signals transmitted from the at least one transmitter, where each of the plurality of signals has a different propagation path, determining, using the motion module, a motion of the antenna of the receiver, generating a plurality of phasors sequences, where each phasor sequence represents a hypothesis based on antenna motion and a direction of arrival estimate for each of the plurality of received signals, compensating the plurality of received signals, a plurality of local signals or correlation results from correlating the plurality of received signals with the local signals using the plurality of phasor sequences based on the plurality of hypotheses regarding the receiver motion and the direction of arrival estimate to generate a plurality of compensated correlation results, determining a preferred hypothesis in the plurality of hypotheses for each received signal that optimizes each correlation result in the plurality of compensated correlation results, identifying a direction of arrival for each of the plurality of received signals using the determined preferred hypothesis, determining, based on the identified direction of arrival, a propagation path for each of the plurality of received signals, and determining at least one characteristic of a propagation path for at least one of the plurality of received signals based on the identified direction of arrival of the propagation path and information regarding the communication environment of the receiver.

In some embodiments, in the method, apparatus, and system the information regarding the communication environment comprises a model of the communication environment and the method comprises combining information regarding an identified direction of arrival with information in the model to determine the at least one characteristic of the propagation path for each of the plurality of received signals.

In some embodiments, in the method, apparatus, and system the model includes a three-dimensional model of the communication environment comprising geometric information including at least one of location, size, shape, or material of reflective surfaces of radio signals proximate the receiver including at least one of buildings, signposts, or telephone poles.

In some embodiments, the method, apparatus, and system can further include selecting at least one of the plurality of signals transmitted from the transmitter to receive at the receiver based on the determined at least one characteristic.

In some embodiments, the method, apparatus, and system can further include determining a position of the receiver based on at least a known position of the transmitter, an identified direction of arrival of at least one of the plurality of signals received from the transmitter, and a determined at least one characteristic of the propagation path for the at least one of the plurality of signals received from the transmitter.

In some embodiments, the method, apparatus, and system can further include determining a position of the transmitter based on at least an estimated position of the receiver, an identified direction of arrival of at least one of the plurality of signals received from the transmitter, and a determined at least one characteristic of the propagation path for the at least one of the plurality of signals received from the transmitter.

In some embodiments, the method, apparatus, and system can further include comparing an identified direction of arrival for at least one of the plurality of received signals to a known, accurate direction of arrival for the at least one of the plurality of received signals to determine corrections for the information regarding the communication environment of the receiver.

Those skilled in the art will appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate can be transmitted to a computing device via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

1. A method for determining at least one characteristic of a propagation path between a transmitter and a receiver in a communication environment, comprising:
receiving a plurality of signals transmitted from the transmitter, where each of the plurality of signals has a different propagation path;
determining a motion of an antenna of the receiver;
generating a plurality of phasors sequences, where each phasor sequence represents a hypothesis based on antenna motion and a direction of arrival estimate for each of the plurality of received signals;
compensating the plurality of received signals, a plurality of local signals or correlation results from correlating the plurality of received signals with the local signals using the plurality of phasor sequences based on the plurality of hypotheses regarding the receiver motion and the direction of arrival estimate to generate a plurality of compensated correlation results;
determining a preferred hypothesis in the plurality of hypotheses for each received signal that optimizes each correlation result in the plurality of compensated correlation results;
identifying a direction of arrival for each of the plurality of received signals using the determined preferred hypothesis;
determining, based on the identified direction of arrival, a propagation path for each of the plurality of received signals; and
determining at least one characteristic of a propagation path for at least one of the plurality of received signals based on the identified direction of arrival of the propagation path and information regarding the communication environment of the receiver.

2. The method according to claim 1, wherein the information regarding the communication environment comprises a model of the communication environment and the method comprises combining information regarding an identified direction of arrival with information in the model to determine the at least one characteristic of the propagation path for each of the plurality of received signals.

3. The method according to claim 2 wherein the model comprises a three-dimensional model of the communication environment comprising geometric information including at least one of location, size, shape, or material of reflective surfaces of radio signals proximate the receiver.

4. The method according to claim 1, further comprising:
selecting at least one of the plurality of signals transmitted from the transmitter to receive at the receiver based on the determined at least one characteristic.

5. The method according to claim 1, further comprising:
determining a position of the receiver based on at least a known position of the transmitter, an identified direction of arrival of at least one of the plurality of signals received from the transmitter, and a determined at least one characteristic of the propagation path for the at least one of the plurality of signals received from the transmitter.

6. The method according to claim 1, further comprising;
determining a position of the transmitter based on at least an estimated position of the receiver, an identified direction of arrival of at least one of the plurality of signals received from the transmitter, and a determined at least one characteristic of the propagation path for the at least one of the plurality of signals received from the transmitter.

7. The method according to claim 1, further comprising using the identified direction of arrival to update the information regarding the communication environment of the receiver.

8. The method according to claim 1, wherein the at least one characterization of the propagation path comprises at least one of a reflection angle of incidence, signal polarization, a reflective surface characterization, or a number of reflections.

9. The method according to claim 1, wherein the at least one characterization of the propagation path comprises a reflection angle of incidence and the method further comprises selecting a received signal for further processing when the reflection angle of incidence for the received signal is less than 75 degrees.

10. An apparatus for determining at least one characteristic of a propagation path between a transmitter and a receiver in a communication environment, comprising:
at least one processor and at least one memory for storing programs and instructions that, when executed by the at least one processor, causes the apparatus to perform operations comprising:
receiving a plurality of signals transmitted from the transmitter, where each of the plurality of signals has a different propagation path;
determining a motion of an antenna of the receiver;
generating a plurality of phasors sequences, where each phasor sequence represents a hypothesis based on antenna motion and a direction of arrival estimate for each of the plurality of received signals;
compensating the plurality of received signals, a plurality of local signals or correlation results from correlating the plurality of received signals with the local signals using the plurality of phasor sequences based on the plurality of hypotheses regarding the receiver motion and the direction of arrival estimate to generate a plurality of compensated correlation results;
determining a preferred hypothesis in the plurality of hypotheses for each received signal that optimizes each correlation result in the plurality of compensated correlation results;
identifying a direction of arrival for each of the plurality of received signals using the determined preferred hypothesis;
determining, based on the identified direction of arrival, a propagation path for each of the plurality of received signals; and
determining at least one characteristic of a propagation path for at least one of the plurality of received signals based on the identified direction of arrival of the propagation path and information regarding the communication environment of the receiver.

11. The apparatus according to claim 10, wherein the information regarding the communication environment comprises a model of the communication environment and the apparatus further performs combining information regarding an identified direction of arrival with information in the model to determine the at least one characteristic of the propagation path for each of the plurality of received signals.

12. The apparatus according to claim 10, wherein the model comprises a three-dimensional model of the communication environment comprising geometric information including at least one of location, size, shape, or material of reflective surfaces of radio signals proximate the receiver.

13. The apparatus according to claim 10, wherein the apparatus further performs:
selecting at least one of the plurality of signals transmitted from the transmitter to receive at the receiver based on the determined at least one characteristic.

14. The apparatus according to claim 10, wherein the apparatus further performs:
determining a position of the receiver based on at least a known position of the transmitter, an identified direction of arrival of at least one of the plurality of signals received from the transmitter, and a determined at least one characteristic of the propagation path for the at least one of the plurality of signals received from the transmitter.

15. The apparatus according to claim 10, wherein the apparatus further performs;
determining a position of the transmitter based on at least a known position of the receiver, an identified direction of arrival of at least one of the plurality of signals received from the transmitter, and a determined at least one characteristic of the propagation path for the at least one of the plurality of signals received from the transmitter.

16. The apparatus according to claim 10, wherein the apparatus further performs:
using an identified direction of arrival for at least one of the plurality of received signals update the information regarding the communication environment of the receiver.

17. The apparatus according to claim 10, wherein the at least one characterization of the propagation path comprises at least one of a reflection angle of incidence, signal polarization, a reflective surface characterization, or a number of reflections.

18. The apparatus according to claim 10, wherein the at least one characterization of the propagation path comprises a reflection angle of incidence and the apparatus further performs selecting a received signal for further processing when the reflection angle of incidence for the received signal is less than 75 degrees.
